(19) United States
(12) Patent Application Publication
(10) Pub. No.: US 2024/0062475 A1
(43) Pub. Date: Feb. 22, 2024

(54) ENSURING VIRTUAL REALITY OBJECTS ACCURATELY REPLICATE PHYSICAL PROPERTIES DURING VR SIMULATION

(71) Applicant: INTERNATIONAL BUSINESS MACHINES CORPORATION, ARMONK, NY (US)

(72) Inventors: Atul Mene, Morrisville, NC (US); Tushar Agrawal, West Fargo, ND (US); Jeremy R. Fox, Georgetown, TX (US); Sarbajit K. Rakshit, Kolkata (IN)

(21) Appl. No.: 17/820,892

(22) Filed: Aug. 19, 2022

(51) Int. Cl. G06T 19/00; G06N 5/02

(52) U.S. Cl. CPC G06T 19/006; G06N 5/022

(57) ABSTRACT

According to one embodiment, a method, computer system, and computer program product for determining and mapping object properties of virtual reality objects during virtual reality simulation is provided. The present invention may include mapping at least one virtual content object to one or more reference objects; creating at least one virtual reality simulation object based on the mapping of the at least one virtual content object to the one or more reference objects; determining physical properties of the one or more reference objects using behavioral rules; and modifying the at least one virtual reality simulation object based on the determined physical properties of the one or more reference objects.

### BACKGROUND

The present invention relates, generally, to the field of computing, and more particularly to virtual reality.

Virtual Reality (VR) is a modern computer technology that uses software to create computer-generated environments. Virtual reality creates digital worlds comprising digital objects that appear to be real and thus, make a user feel as if they are immersed in their surroundings. Currently, virtual reality objects can be introduced into a simulated environment by inserting a predefined mapping of data into the virtual reality system. However, for a virtual reality system to provide a user with as real of a simulated environment as possible, the virtual reality object's physical properties need to be as accurate as they can be to the real world objects to which they are mapped, therefore, ensuring proper behavior is displayed. The behavior of virtual reality objects is one of the driving factors of success in virtual reality and greatly impacts a user's experience in a simulation. Thus, an improvement in virtual reality has the potential to benefit the overall user experience.

### SUMMARY

According to one embodiment, a method, computer system, and computer program product for determining and mapping object properties of virtual reality objects during virtual reality simulation is provided. The present invention may include mapping at least one virtual content object to one or more reference objects; creating at least one virtual reality simulation object based on the mapping of the at least one virtual content object to the one or more reference objects; determining physical properties of the one or more reference objects using behavioral rules; and modifying the at least one virtual reality simulation object based on the determined physical properties of the one or more reference objects.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2 illustrates an exemplary application environment according to at least one embodiment;

FIG. 3 is an operational flowchart illustrating a virtual reality object properties mapping determination process according to at least one embodiment;

FIG. 4 is a system diagram illustrating an exemplary program environment of an implementation of a virtual reality object properties mapping determination process according to at least one embodiment; and

FIG. 5 is a block diagram of internal and external components of computers and servers depicted in FIG. 1 according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

In a virtual reality simulated environment, virtual reality objects can currently be created based on a predefined mapping of data, which may result in the virtual reality objects comprising an inaccurate mapping of their physical properties. Inaccurate mapping of virtual reality objects can lead to a poor user experience, such as when a user interacts with virtual reality objects displaying inaccurate behavior and thus, experiences an inaccurate simulated scenario. For example, if a user is testing machinery in a simulated virtual reality scenario and the physical properties of the machinery and/or other virtual reality objects are inaccurate, the user may likely not receive proper training that would aid the user in a real-world scenario. Therefore, it may be likely that a user has a poor virtual reality experience because of interactions with virtual reality objects that contain inaccurate physical properties.

One way in which current methods attempt to address problems with creating virtual reality objects is by predefining a virtual reality object corresponding to a real-world object. Predefining a virtual reality object corresponding to a real-world object can allow a user to see and interact with a virtual reality object. However, several deficiencies exist with predefining virtual reality objects. One of the deficiencies of predefining virtual reality objects is that the virtual reality objects' behavior is static because the virtual reality objects are created using a one-time assignment of physical properties. For example, a virtual reality object's behavior cannot be updated based on different scenarios in the virtual environment, thus limiting the properties of the virtual reality object to only those properties contained within the initial metadata. Another deficiency of predefining a virtual reality object is that the virtual reality object can only be mapped to one reference object. For example, a virtual reality object cannot be mapped to multiple reference objects, thus limiting the accuracy of the virtual reality object's physical properties because the virtual reality object may be representative of only one embodiment. Thus, an improvement in virtual reality has the potential to enhance users' interactions with virtual reality objects in a simulated world, and thus, benefit the overall user experience.

The present invention has the capacity to improve virtual reality by mapping virtual content objects to one or more reference objects to produce virtual reality objects displaying proper behavior. Accordingly, it may be advantageous to, among other things, implement a system that improves the physical properties of virtual reality objects. For example, a virtual reality object may be mapped to one or more reference objects, thus enabling a simulated VR environment in which virtual reality objects comprise proper physical properties, and therefore, ensuring an accurate user experience. This improvement in the physical properties of virtual reality objects can be accomplished by implementing a system that maps virtual content objects to reference objects to create VR simulation objects, applies behavioral rules to VR simulation objects to assign them appropriate physical properties and/or assigned appropriate resultant physical properties, and modifies the physical properties of the VR simulation objects based on the identified physical properties of the reference objects.

According to one embodiment, the invention is a system, method, and/or computer program product for utilizing one or more reference objects and behavioral rules to both create VR simulation objects and modify the physical properties of the VR simulation objects so that the VR simulation objects may accurately resemble the one or more reference objects to which they are mapped in both appearance and behavior during different scenarios within the simulated environment.

In some embodiments of the invention, the virtual reality object properties mapping determination program, herein referred to as “the program”, can determine an environment to be simulated by VR. An environment to be simulated by VR, herein referred to as “the environment”, can be based on an administrator's real-world surroundings, a real-world location, and/or an environment comprised within the program's content repository, such as a previously captured virtual reality environment. An administrator may be a person who is performing mapping of VR simulation and/or programming or monitoring a VR simulation. The program can determine the environment after receiving a notification to capture from an administrator. The administrator may select an environment and send a notification to the program, such as by pressing a prompt on the program's interface, to capture the environment. The program may capture the environment by taking one or more images using a camera. A camera may be any device for recording visual images in the form of photographs, films, or video signals.

The program may analyze the image(s) corresponding to the environment and create a virtual reality simulation model based on the environment. A VR simulation model may be a digitalized version of the environment. Additionally, the program may analyze image(s) corresponding to the environment to create virtual content objects, which may be displayed in the VR simulation model. Virtual content objects may be digital models the program creates to behave as the virtual content objects' real-world object counterparts. In a simulation model, each virtual content object may be identified as a unique object. The VR simulation model may be displayed on any device capable of displaying images, such as a VR headset or television.

The program may identify and determine reference objects based on the analysis of the image(s) corresponding to the environment. A reference object may be a real-world object and/or digital object that the program maps to virtual content objects. The reference object can be taken from one or more images of the environment and/or any reference VR content from the content repository that comprises objects displaying physical properties. The physical properties of reference objects may be identified from video analysis, image analysis, IoT feed, etc. Physical properties may comprise properties of motion, such as displacement or velocity, directions of motion, such as horizontal or vertical, statics or dynamics, temperatures, weights, etc.

The program can map a virtual content object to one or more reference objects to create virtual reality (VR) simulation objects. VR simulation objects may be digital objects that are displayed in a VR simulated environment, which a user can see and interact with in the VR simulated environment. A user can be any person immersed in the VR simulated environment. Virtual content objects and reference objects may be mapped together one-to-one (1:1) and/or one-to-several (1:X). Additionally, a reference object may be mapped to one or more different virtual content objects at the same and/or different times. Also, a virtual content object may be mapped to one or more different reference objects at the same and/or different times. Mapping virtual content objects to reference objects can give the VR simulation objects the physical properties of one or more reference objects, in real-time or at a certain moment in time, and the behavior of the VR simulation objects may resemble the real-world behavior of the respective reference objects. If multiple virtual content objects are mapped to a single reference object, the program may identify the resultant physical properties of the reference objects. The resultant physical properties may comprise substantially similar properties as the physical properties comprise, except that the resultant physical properties only refer to the physical properties of VR simulation objects mapped 1:X, and not 1:1.

The program can determine if the mapping of a virtual content object to a reference object is 1:1 or 1:X, where X equals a whole number greater than 1. The program may determine whether a virtual content object is mapped 1:1 to a reference object by checking the content repository in the database. The program may look at existing objects in the content repository and determine if an existing reference object's properties match that of the virtual content object's properties. If an existing reference object's properties match that of the virtual content object's properties, the program may confirm a 1:1 mapping. If no existing reference object's properties match that of the virtual content object's properties, the program may confirm a 1:X mapping.

The program may create behavioral rules that modify the mapping of the VR simulation objects. Behavioral rules may be rules that determine which physical properties of the one or more reference objects a simulation object will comprise in each scenario occurring within a simulated environment. Behavioral rules may be based on the context metadata of both real and virtual objects. A behavioral rule can analyze the context of a simulation, types of simulation objects, types of mapping, etc. When a simulation occurs, the program can identify the contextual situation of the simulation and determine the appropriate mapping of a VR simulation object based on the behavioral rules. A behavioral rule may map a virtual content object to multiple reference objects, or certain reference objects at different times or for certain ranges of time. If a virtual content object is mapped to more than one reference object, the program can extract the resultant physical properties from the reference objects to which the virtual content object is mapped. Additionally, a behavior rule may map multiple virtual content objects to a single reference object. Behavioral rules may be updated over time and based on an update, can improve how a VR simulation object behaves in a scenario within a simulated environment.

If the program confirms a 1:1 mapping, the program may apply behavioral rules to the VR simulation object to assign it with appropriate physical properties. Specifically, the program may apply behavioral rules to a VR simulation object and assign the appropriate physical properties from the reference object to which the VR simulation object is mapped. The appropriate physical properties from a reference object may be the physical properties that a VR simulation object needs for each scenario occurring within the simulated environment. For example, if the VR simulation object is a bench, the behavioral rules may identify the static nature of the bench and the weight of the bench for the current scenario occurring within the simulated environment. Also, the behavior rules may identify that in some scenarios the bench may have a person sitting on it and/or assign a bench a stained wooden texture look and feel, that a user may touch in the simulated environment.

If the program confirms a 1:X mapping, the program may apply behavioral rules to the VR simulation object to assign it with appropriate resultant physical properties. Specifically, the program may apply the behavioral rules to identify what resultant physical properties of the VR simulation object are to be used in the different scenarios occurring within the simulated environment. For example, the program may determine that an analyzed reference image comprises both a school bus and a public transportation bus. The program may create a virtual content object of a bus and map the bus to both the school bus and the public transportation bus reference objects. The behavioral rules may determine which physical properties of the reference objects apply to the virtual content object. For example, the school bus and public transportation bus may differ in their assigned physical properties such as where and how often each bus stops and/or each bus may differ in behavior between an urban environment and a rural environment.

The program may modify the physical properties of VR simulation objects with their assigned appropriate physical properties and/or assigned appropriate resultant physical properties. The program may modify the physical properties of a VR simulation object by adjusting the VR simulation object's mapping to the one or more reference objects to which the VR simulation object is mapped. For example, in a certain scenario, the program may modify the physical properties of a VR simulation object such as a person, creating a person that is riding a skateboard during the day and walking during the night. Thus, the modified VR simulation objects may accurately resemble the one or more reference objects to which they are mapped in both appearance and behavior during different scenarios within the simulated environment.

In some embodiments of the invention, an administrator may modify the mapping between the virtual content objects and the reference objects. An administrator may modify the mapping between virtual content objects and reference objects to get a VR simulation object's physical properties closer to the one or more reference objects to which it is mapped. Additionally, an administrator may modify a behavioral rule. Upon a change in the mapping between a virtual content object and one or more reference objects, and/or a behavioral rule, the program may save the modification and update the respective VR simulation objects and the respective VR simulation environments accordingly.

The program can create a knowledge corpus. The knowledge corpus can be created and maintained in the system's database. The knowledge corpus may comprise a content repository comprising a memory of the mapping of virtual content objects and reference objects, current and previously mapped VR simulation objects, current and previously mapped reference objects, the context of an object's surroundings, VR simulated environments and the context of scenarios in the simulated environments, VR simulation models, the behavioral rules, and previous images that were analyzed by the program. When a simulated VR model is created, the program may save the mapping of the virtual content objects and reference objects. Using the saved mapping, the program may create an auto-mapping of the virtual content objects with reference objects for use in a simulated environment. Additionally, the program may recommend previously mapped reference objects to map with a virtual content object.

An exemplary use of the invention may involve the program creating a VR simulated environment based on a city. The program can determine a city as the environment to be simulated by an administrator setting up a camera and prompting the program to take images of the city with the camera. The program may analyze the images of the city from the camera and may create a VR simulation model of the city and virtual content objects based on the analysis of the city images. The program may determine the reference objects identified in the images such as a bus, car, people, buildings, benches, signs, roads, etc. Each of the previously mentioned reference objects may be identified as a unique object and may be mapped to virtual content objects to create VR simulation objects. The program may check the content repository to determine if the mapping of the simulation object, for example, a bench, is 1:1 or 1:X. If the program checks the content repository and determines that the mapping of the bench is 1:1, the program may apply behavior rules to the VR simulation object to assign the appropriate physical properties, such as the color and weight of the bench, to the VR simulation object. If the program checks the content repository and determines that the mapping of a VR simulation object, for example, a car, is not 1:1, and 1:3 for example, the program may apply behavior rules to the simulation objects, the 3 unique cars in the scenario, to assign the appropriate resultant physical properties to the VR simulation objects. The program may modify the physical properties of the VR simulation objects, for example changing the color, max speed, and/or direction of the cars, with the assigned appropriate physical properties, resulting in the modified VR simulation objects more accurately resembling the one or more reference objects to which they are mapped in both appearance and behavior.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The following described exemplary embodiments provide a system, method, and program product to determine both a simulated environment and reference objects based on an analysis of images corresponding to a determined simulated environment, map virtual content objects to reference objects to create VR simulation objects, apply behavioral rules to VR simulation objects to assign them appropriate physical properties or appropriate resultant physical properties, and modify the physical properties of VR simulation objects with the assigned appropriate physical properties.

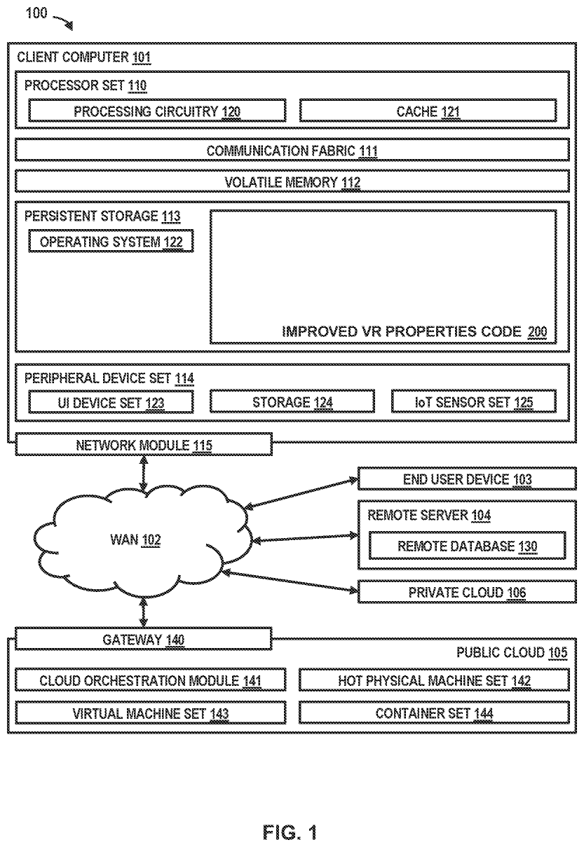

Referring to FIG. 1, an exemplary networked computer environment 100 is depicted, according to at least one embodiment. Computing environment 100 contains an example of an environment for the execution of at least some of the computer code involved in performing the inventive methods, such as improved VR properties code 200. In addition to code block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and code block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in code block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

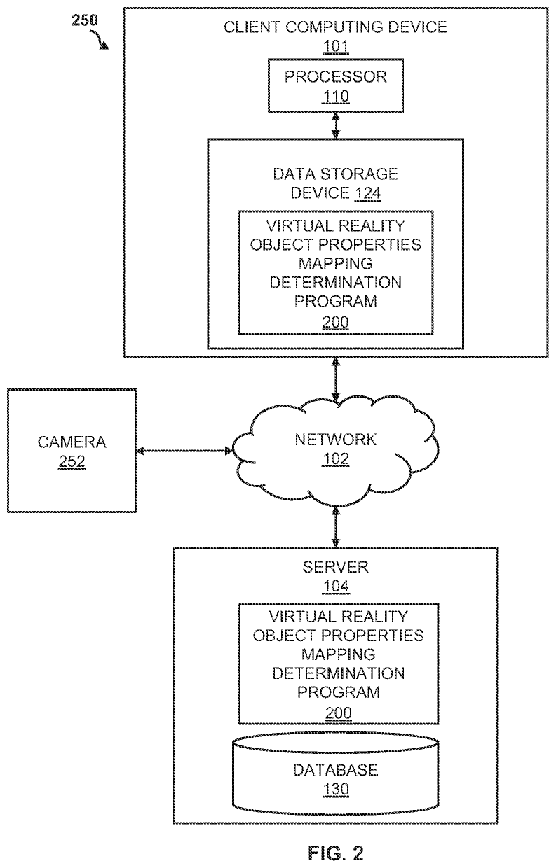

Referring to FIG. 2, an exemplary application environment 250 is depicted, according to at least one embodiment. The application environment 250 may include client computing device 101 and a remote server 104 interconnected via a communication network 102. According to at least one implementation, the application environment 250 may include a plurality of client computing devices 101 and remote servers 104, of which only one of each is shown for illustrative brevity. It may be appreciated that FIG. 2 provides only an illustration of one implementation and does not imply any limitations with regard to the environments in which different embodiments may be implemented. Many modifications to the depicted environments may be made based on design and implementation requirements.

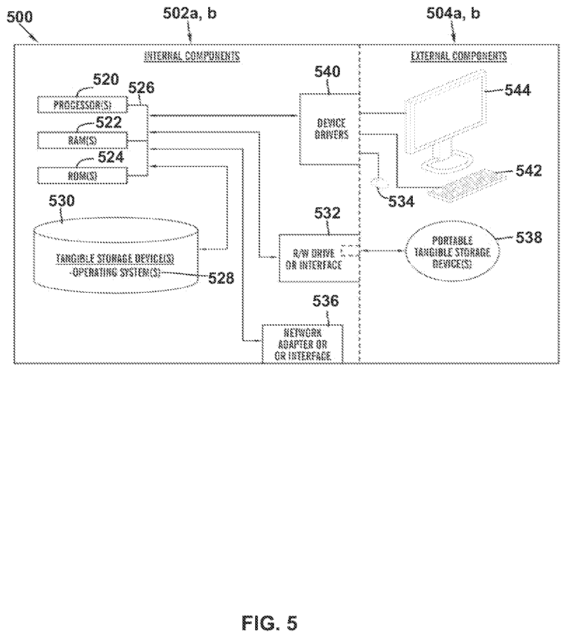

Client computing device 101 may include a processor 110 and a data storage device 124 that is enabled to host and run a virtual reality object properties mapping determination program 200 and communicate with the remote server 104 via the communication network 102, in accordance with one embodiment of the invention. As will be discussed with reference to FIG. 5, the client computing device 101 may include internal components 502a and external components 504a, respectively.

The remote server computer 104 may be a laptop computer, netbook computer, personal computer (PC), a desktop computer, or any programmable electronic device or any network of programmable electronic devices capable of hosting and running a virtual reality object properties mapping determination program 200 and a database 130 and communicating with the client computing device 101 via the communication network 102, in accordance with embodiments of the invention. As will be discussed with reference to FIG. 5, the remote server computer 104 may include internal components 502b and external components 504b, respectively. The remote server 104 may also operate in a cloud computing service model, such as Software as a Service (SaaS), Platform as a Service (PaaS), or Infrastructure as a Service (IaaS). The remote server 104 may also be located in a cloud computing deployment model, such as a private cloud, community cloud, public cloud, or hybrid cloud.

The database 130 may be a digital repository capable of data storage and data retrieval. The database 130 can be present in the remote server 104 and/or any other location in the network 102. The database 130 may include a knowledge corpus.

The camera device 252 may be any device capable of recording visual images in the form of photographs, films, or video signals, such as a physical or virtual camera.

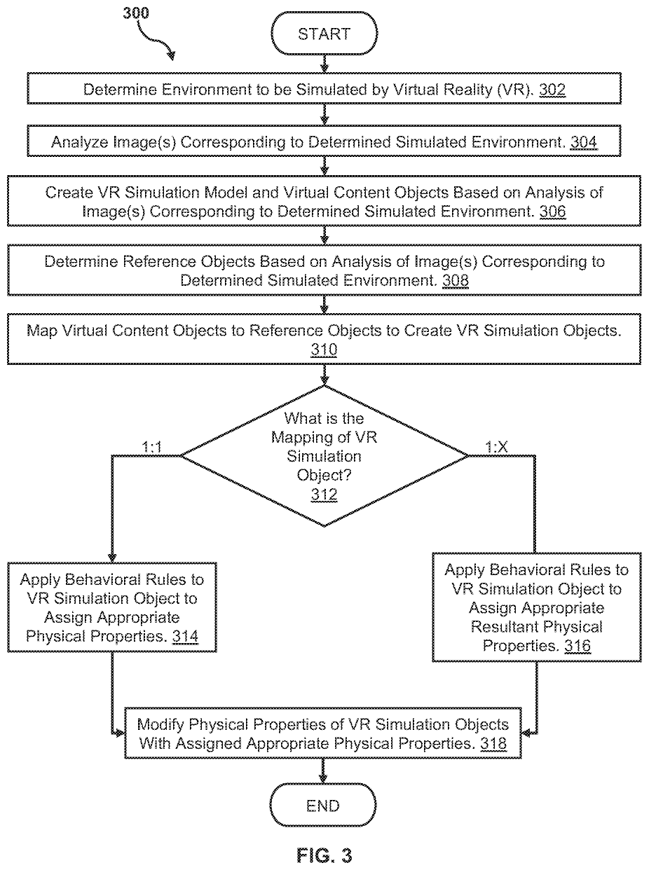

According to the present embodiment, the virtual reality object properties mapping determination program 200 may be a program 200 capable of mapping virtual content objects with reference objects to create VR simulation objects, applying behavioral rules to VR simulation objects to assign them appropriate physical properties or appropriate resultant physical properties, modifying the physical properties of the VR simulation objects based on the identified physical properties of the reference objects, and creating virtual reality simulation models. The program 200 may be located on client computing device 101 or remote server 104 or on any other device located within network 102. Furthermore, the virtual reality object properties mapping determination program 200 may be distributed in its operation over multiple devices, such as client computing device 101 and remote server 104. The virtual reality properties object mapping determination method is explained in further detail below with respect to FIG. 3.

Referring now to FIG. 3, an operational flowchart illustrating a virtual reality properties object mapping determination process 300 is depicted according to at least one embodiment. At 302, the program 200 determines an environment to be simulated by virtual reality (VR). An environment to be simulated by VR, herein referred to as “the environment”, can be based on an administrator's real-world surroundings, a real-world location, and/or an environment comprised within the program's 200 content repository, such as a previously captured virtual reality environment. An administrator may be a person who is performing mapping of VR simulation and/or programming or monitoring a VR simulation. The program 200 can determine the environment after receiving a notification to capture from an administrator. The administrator may select an environment and send a notification to the program 200, such as by pressing a prompt on the program's 200 interface, to capture the environment. The program 200 may capture the environment by taking one or more images using a camera device 252.

At 304, the program 200 analyzes image(s) corresponding to the determined simulated environment. The program analyzes the image(s) corresponding to the environment to identify the context of the environment and the reference objects in the environment. A reference object may be a real-world object and/or digital object that the program maps to virtual content objects.

At 306, the program 200 creates a VR simulation model and VR context objects based on the analysis of the image(s) corresponding to the determined simulated environment. A VR simulation model may be a digitalized version of the environment. Virtual content objects may be digital models the program creates to behave as the content objects' real-world object counterparts. In the simulation model, each virtual content object may be identified as a unique object. The VR simulation model may be displayed on any device capable of displaying images, such as a VR headset or television.

At 308, the program 200 determines reference objects based on the analysis of the image(s) corresponding to the determined simulated environment. The reference object can be taken from one or more images of the environment and/or any reference VR content from the content repository that comprises objects producing physical properties. The physical properties of reference objects may be identified from video analysis, image analysis, IoT feed, etc. Physical properties may comprise properties of motion, such as displacement or velocity, directions of motion, such as horizontal or vertical, statics or dynamics, temperatures, weights, etc. In some embodiments of the invention, the program 200 may recommend previously mapped reference objects to map to a virtual content object.

At 310, the program 200 maps virtual content objects to one or more reference objects to create VR simulation objects. VR simulation objects may be digital objects that are displayed in a VR simulated environment, which a user can see and interact with in the VR simulated environment. A user can be any person immersed in the VR simulated environment. Virtual content objects and reference objects may be mapped together one-to-one (1:1) and/or one-to-several (1:X). Additionally, a reference object may be mapped to one or more different virtual content objects at the same and/or different times. Also, a virtual content object may be mapped to one or more different reference objects at the same and/or different times. Mapping virtual content objects to reference objects can give the VR simulation objects the physical properties of one or more reference objects, in real-time or at a certain moment in time, and the behavior of the VR simulation objects may resemble the real-world behavior of the respective reference objects. If multiple virtual content objects are mapped to a single reference object, the program may identify the resultant physical properties of the reference objects. The resultant physical properties may comprise substantially similar properties as the physical properties comprise, except that the resultant physical properties only refer to the physical properties of VR simulation objects mapped 1:X, and not 1:1.

At 312, the program 200 determines if the mapping of the VR simulation objects is 1:1 or 1:X, based on the virtual content objects being mapped to one or more reference objects. The program 200 may determine whether a virtual content object is mapped 1:1 to a reference object by checking the content repository in the database 130. The program 200 may look at existing reference objects in the content repository and determine if an existing reference object's properties match that of the virtual content object's properties. If an existing reference object's properties match that of the virtual content object's properties, the program 200 may confirm a 1:1 mapping. If no existing reference object's properties match that of the virtual content object's properties, the program 200 may confirm a 1:X mapping.

According to one implementation, if the program 200 determines that the mapping of the VR simulation object is 1:1 (step 312, “Yes” branch), the program 200 may proceed to step 314 to apply the behavioral rules to the VR simulation object to assign the appropriate physical properties to the VR simulation object. If the program 200 determines that the mapping of the VR simulation object is 1:X (step 312, “No” branch), the program 200 may proceed to step 316 to apply the behavioral rules to the VR simulation object to assign the appropriate resultant physical properties of the VR simulation object.

At 314, the program 200 applies the behavioral rules to the VR simulation object to assign the appropriate physical properties to the VR simulation object. Behavioral rules may be rules that determine which physical properties of the one or more reference objects a simulation object will comprise in each scenario occurring within a simulated environment. Behavioral rules may be based on the context metadata of both real and virtual objects. A behavioral rule can analyze the context of a simulation, types of simulation objects, types of mapping, etc. When a simulation occurs, the program 200 can identify the contextual situation of the simulation and determine the appropriate mapping of a VR simulation object based on the behavioral rules. The program 200 may apply behavioral rules to a VR simulation object and assign the appropriate physical properties from the reference object to which the VR simulation object is mapped. The appropriate physical properties from a reference object may be the physical properties that a VR simulation object needs for each scenario occurring within the simulated environment. Behavioral rules may be updated over time and based on an update, can improve how a VR simulation object behaves in a scenario within a simulated environment.

At 316, the program 200 applies the behavioral rules to the VR simulation object to assign the appropriate resultant physical properties to the VR simulation object. The program 200 may apply the behavioral rules to identify what resultant physical properties of the VR simulation object are to be used in the different scenarios occurring within the simulated environment.

At 318, the program 200 modifies the physical properties of the VR simulation objects with the assigned appropriate physical properties of the VR simulation object or the assigned appropriate resultant physical properties of the VR simulation object. The program 200 may modify the physical properties of the VR simulation objects by adjusting the VR simulation object's mapping to the one or more reference objects to which the VR simulation object is mapped. Thus, the modified VR simulation objects may more accurately resemble the one or more reference objects to which they are mapped in both appearance and behavior during different scenarios within the simulated environment.

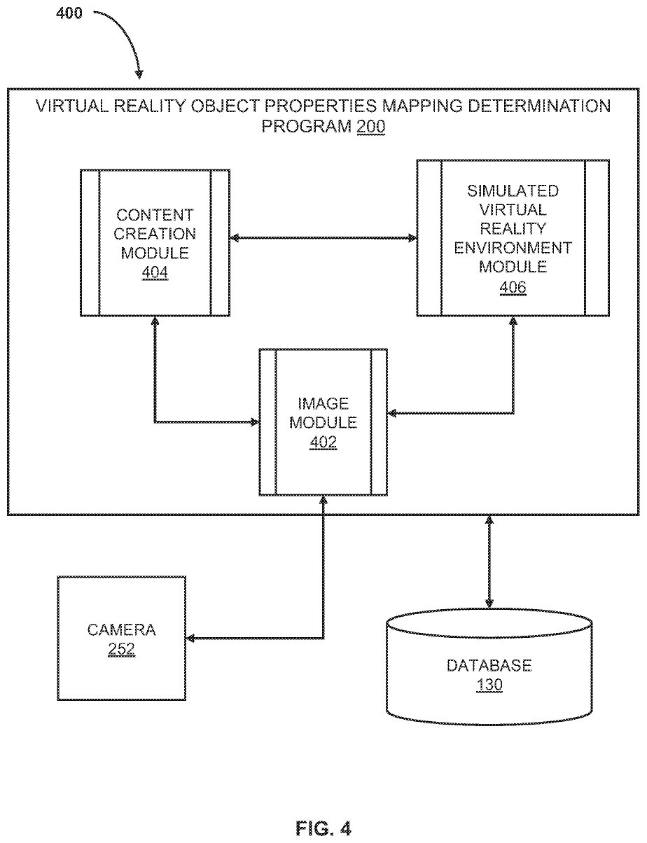

Referring now to FIG. 4, a system diagram illustrating an exemplary program environment 400 of an implementation of a virtual reality object properties mapping determination process 300 is depicted according to at least one embodiment. Here, the program 200 comprises an image module 402, a content creation module 404, and a simulated virtual reality environment module 406. The exemplary program environment 400 details the interactions between the image module 402 and the content creation module 404, the image module 402 and the simulated virtual reality environment module 406, and the content creation module 404 and the simulated virtual reality environment module 406. Additionally, the exemplary program environment 400 details the interactions between the image module 402 and the camera device 252, and the virtual reality object properties mapping determination program 200 and the database 130.

The image module 402 may be used to analyze the selected environment to be simulated and the reference objects. The content creation module 404 may be used to create virtual content objects, the VR simulation objects, and the VR simulated environment. The simulated virtual reality environment module 406 may be used to display the VR simulated environment and the VR simulation objects.

It may be appreciated that FIGS. 2-4 provide only illustrations of implementation and do not imply any limitations with regard to how different embodiments may be implemented. Many modifications to the depicted environments may be made based on design and implementation requirements.

FIG. 5 is a block diagram 500 of internal and external components of the client computing device 101 and the remote server 104 depicted in FIG. 1 in accordance with an embodiment of the present invention. It should be appreciated that FIG. 5 provides only an illustration of one implementation and does not imply any limitations with regard to the environments in which different embodiments may be implemented. Many modifications to the depicted environments may be made based on design and implementation requirements.

The data processing system 502, 504 is representative of any electronic device capable of executing machine-readable program instructions. The data processing system 502, 504 may be representative of a smart phone, a computer system, PDA, or other electronic devices. Examples of computing systems, environments, and/or configurations that may be represented by the data processing system 502, 504 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

The client computing device 101 and the remote server 104 may include respective sets of internal components 502 a, b and external components 504 a, b illustrated in FIG. 5. Each of the sets of internal components 502 include one or more processors 520, one or more computer-readable RAMs 522, and one or more computer-readable ROMs 524 on one or more buses 526, and one or more operating systems 528 and one or more computer-readable tangible storage devices 530. The one or more operating systems 528, the virtual reality object properties mapping determination program 200 in the client computing device 101, and the virtual reality object properties mapping determination program 200 in the remote server 104 are stored on one or more of the respective computer-readable tangible storage devices 530 for execution by one or more of the respective processors 520 via one or more of the respective RAMs 522 (which typically include cache memory). In the embodiment illustrated in FIG. 5, each of the computer-readable tangible storage devices 530 is a magnetic disk storage device of an internal hard drive. Alternatively, each of the computer-readable tangible storage devices 530 is a semiconductor storage device such as ROM 524, EPROM, flash memory or any other computer-readable tangible storage device that can store a computer program and digital information.

Each set of internal components 502 a, b also includes a R/W drive or interface 532 to read from and write to one or more portable computer-readable tangible storage devices 538 such as a CD-ROM, DVD, memory stick, magnetic tape, magnetic disk, optical disk or semiconductor storage device. A software program, such as the virtual reality object properties mapping determination program 200, can be stored on one or more of the respective portable computer-readable tangible storage devices 538, read via the respective RAY drive or interface 532, and loaded into the respective hard drive 530.

Each set of internal components 502 a, b also includes network adapters or interfaces 536 such as a TCP/IP adapter cards, wireless Wi-Fi interface cards, or 3G or 4G wireless interface cards or other wired or wireless communication links. The virtual reality object properties mapping determination program 200 in the client computing device 101 and the virtual reality object properties mapping determination program 200 in the remote server 104 can be downloaded to the client computing device 101 and the remote server 104 from an external computer via a network (for example, the Internet, a local area network or other, wide area network) and respective network adapters or interfaces 536. From the network adapters or interfaces 536, the virtual reality object properties mapping determination program 200 in the client computing device 101 and the virtual reality object properties mapping determination program 200 in the remote server 104 are loaded into the respective hard drive 530. The network may comprise copper wires, optical fibers, wireless transmission, routers, firewalls, switches, gateway computers and/or edge servers.

Each of the sets of external components 504 a, b can include a computer display monitor 544, a keyboard 542, and a computer mouse 534. External components 504 a, b can also include touch screens, virtual keyboards, touch pads, pointing devices, and other human interface devices. Each of the sets of internal components 502 a, b also includes device drivers 540 to interface to computer display monitor 544, keyboard 542, and computer mouse 534. The device drivers 540, RAY drive or interface 532, and network adapter or interface 536 comprise hardware and software (stored in storage device 530 and/or ROM 524).

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method for determining and mapping object properties of virtual reality objects during virtual reality simulation, the method comprising:
mapping at least one virtual content object to one or more reference objects;
creating at least one virtual reality simulation object based on the mapping of the at least one virtual content object to the one or more reference objects;
determining physical properties of the one or more reference objects using behavioral rules; and
modifying the at least one virtual reality simulation object based on the determined physical properties of the one or more reference objects.

2. The method of claim 1, further comprising:
determining an environment to be simulated by virtual reality; and
creating a virtual reality simulated model based on the determined environment to be simulated by virtual reality.

3. The method of claim 1, further comprising:
creating a knowledge corpus that stores context of virtual reality simulated models, reference objects, and scenarios of simulations.

4. The method of claim 3, wherein mapping the at least one virtual content object to the one or more reference objects further comprises recommending previously used reference objects to map to the at least one virtual content object.

5. The method of claim 1, wherein the physical properties of the one or more reference objects comprise resultant physical properties.

6. The method of claim 1, wherein the physical properties of the at least one virtual reality simulation object are updated based on a change in the determined physical properties of the one or more reference objects using the behavioral rules.

7. The method of claim 1, wherein the behavioral rules comprise rules that analyze simulation contexts, object context, types of simulation objects, and/or types of mapping.

8. A computer system for determining and mapping object properties of virtual reality objects during virtual reality simulation, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
mapping at least one virtual content object to one or more reference objects;
creating at least one virtual reality simulation object based on the mapping of the at least one virtual content object to the one or more reference objects;
determining physical properties of the one or more reference objects using behavioral rules; and
modifying the at least one virtual reality simulation object based on the determined physical properties of the one or more reference objects.

9. The computer system of claim 8, further comprising:
determining an environment to be simulated by virtual reality; and
creating a virtual reality simulated model based on the determined environment to be simulated by virtual reality.

10. The computer system of claim 9, further comprising:
creating a knowledge corpus that stores context of virtual reality simulated models, reference objects, and scenarios of simulations.

11. The computer system of claim 10, wherein mapping the at least one virtual content object to the one or more reference objects further comprises recommending previously used reference objects to map to the at least one virtual content object.

12. The computer system of claim 8, wherein the physical properties of the one or more reference objects comprise resultant physical properties.

13. The computer system of claim 8, wherein the physical properties of the at least one virtual reality simulation object are updated based on a change in the determined physical properties of the one or more reference objects using the behavioral rules.

14. The computer system of claim 8, wherein the behavioral rules comprise rules that analyze simulation contexts, object context, types of simulation objects, and/or types of mapping.

15. A computer program product for determining and mapping object properties of virtual reality objects during virtual reality simulation, the computer program product comprising:
one or more computer-readable tangible storage medium and program instructions stored on at least one of the one or more tangible storage medium, the program instructions executable by a processor to cause the processor to perform a method comprising:
mapping at least one virtual content object to one or more reference objects;
creating at least one virtual reality simulation object based on the mapping of the at least one virtual content object to the one or more reference objects;
determining physical properties of the one or more reference objects using behavioral rules; and
modifying the at least one virtual reality simulation object based on the determined physical properties of the one or more reference objects.

16. The computer program product of claim 15, further comprising:
determining an environment to be simulated by virtual reality; and
creating a virtual reality simulated model based on the determined environment to be simulated by virtual reality.

17. The computer program product of claim 16, further comprising:
creating a knowledge corpus that stores context of virtual reality simulated models, reference objects, and scenarios of simulations.

18. The computer program product of claim 17, wherein mapping the at least one virtual content object to the one or more reference objects further comprises recommending previously used reference objects to map to the at least one virtual content object.

19. The computer program product of claim 15, wherein the physical properties of the one or more reference objects comprise resultant physical properties.

20. The computer program product of claim 15, wherein the physical properties of the at least one virtual reality simulation object are updated based on a change in the determined physical properties of the one or more reference objects using the behavioral rules.
